(19) United States
(12) Patent Application Publication
(10) Pub. No.: US 2008/0043471 A1
(43) Pub. Date: Feb. 21, 2008

(54) Motion activated night light with extended battery life

(76) Inventors: Bryan H. Musgrove, Meridian, ID (US); Clifton J. Seusy, Boise, ID (US)

Correspondence Address: PEDERSEN & COMPANY, PLLC, P.O. BOX 2666, BOISE, ID, 83701, US

(21) Appl. No.: 11/507,756

(22) Filed: Aug. 21, 2006

(51) Int. Cl. F21V 23/04

(52) U.S. Cl. 362/276; 362/802

(57) ABSTRACT

A night light device that provides low level illumination, which turns on automatically when motion is detected near the device and only if the ambient lighting level is too low. The device operates using battery power and is only activated upon detecting both motion and low ambient light level simultaneously. The device will remain active for a period of thirty seconds unless additional motion is detected, in which case it will remain active for thirty seconds after the last detected motion. Two AA alkaline cells are expected to last for one year at an average of 35 light activations per day, resulting in usability and cost efficiency. The device may also be held in the hand for use as a low-lighting flashlight. Illumination with both functions is provided by a single light source, reducing the energy consumption and cost for the user.

### BACKGROUND OF THE INVENTION

1. Field of the Invention

This invention relates generally to low level illumination night lamps, beacons and signals for lighting walkways and such, and more particularly to a self-contained, portable nightlight having a motion detection system for controlling the switching of illumination so as to extend the life of a powering energy cell or battery.

2. Description of the Related Art

Ness, U.S. Pat. No. 5,763,872, describes a wall-mounted night light device that provides a low level illumination using electro-phosphorescent lighting, which is automatically turned on when motion near the device is detected by the device, and when the ambient lighting level is too low to see without artificial light. A high intensity lighting feature allows the device to be used as a flashlight during emergencies. The device preferably has phosphorescent doping within its case structure so as to provide a dim light even when not energized. This assembly possesses two separate lamps, one of low intensity with an automatic shut-off feature, and one of high intensity with no automatic shut-off feature.

Dalton et al., U.S. Pat. No. 5,806,961, describes a rechargeable flashlight having a first lamp for providing a conventional flashlight beam, and a second lamp for providing a nightlight function. The power supply includes a replaceable, rechargeable battery, and an electrical connector is provided and configured to move between a first and second position to selectively recharge the battery therein. Two different light sources are used to achieve the flashlight and nightlight combination.

Chien, U.S. Pat. No. 6,179,431, describes a flashlight with a function for providing a conventional light source, such as an incandescent bulb or other bulb, combined with a method for providing low intensity electro-luminescent lighting. This arrangement allows for the emission of various light intensities and power consumption, and therefore the flashlight could serve not only in the conventional capacity, but also as a night light, warning beacon, or light stick. This device requires the use of two sources to achieve the two functions.

Chien, U.S. Published Pat. App. No. US 2001/0033481 A1, describes an electro-luminescent lighting arrangement which includes at least one additional lighting element for emitting different light intensities in order to perform different functions, such as flashlight, lantern, or warning light. Again, two lighting elements are used with this invention.

Hanis et al., U.S. Published Pat. App. No. US 2005/0078481, describes a portable, motion-sensitive illumination device, capable of illuminating an item stored on or near the device, such as eyeglasses, drinking cups, etc. Illumination by the device remains active for a certain period of time, after which the device resets to be triggered by subsequent motion, heat, or other stimuli detectable by the device. This invention is a storage device, using one LED lamp underneath a light chamber to produce low intensity “passive” light.

The prior art teaches the use of motion sensing and lighting devices, each with limitations on use due to power supply. The present invention relies on a single light source to act in both capacities as night light and flashlight, and in this way is able to conserve and extend the battery life and drive down the cost to the user. The present invention is simple to use, energy efficient, and therefore cost efficient.

A primary objective of the present invention is to provide a night light that is both user-friendly and economical because it relies only on battery power, which can be replaced quickly and easily by the user.

Another objective is to provide such a night light that is economical in cost to the consumer because it avoids unnecessary activations during times of threshold ambient lighting conditions.

Another objective is to provide a night light device that is compact, light-weight, and readily held in the palm of the user's hand.

A further objective is to provide a night light device that is able to function as a flashlight without emitting a glaring, bright light that is jarring to the eye.

### BRIEF SUMMARY OF THE INVENTION

The present invention provides a night light device having a low level illumination that is automatically turned on when motion near the device is detected by the device and if the ambient lighting level is low. When the ambient light level is above a specified level so that it is possible to see without artificial light, the device does not illuminate. The compact, battery-operated nature of the device also allows the device to be used as a portable low-illumination flashlight for guiding a person to the bathroom or other room in the house during the middle of the night. This is accomplished through the use of a single light source that focuses its maximum beam intensity substantially in a single direction, while providing a very low beam intensity in any other direction, resulting in a minimally diffuse light. Because of the low-lighting flashlight feature, a person using the portable night light can walk safely to another room without requiring the use of a glaring, higher-intensity light source. The device requires, for example, only two AA alkaline batteries for operation, and it is expected that the battery life of the device will be about one year with an average of 35 activations per day. The batteries are easily changeable by the user through the feature of a snap-in/-out battery compartment cover. The device can be placed anywhere that is of the greatest convenience to the user, such as resting on the floor, mounted on the wall, or mounted on any other surface with pressure-sensitive adhesive or with a conventional hook-and-loop fastener. The device is of a simple construction, that provides energy efficiency and cost-effectiveness to the user.

### BRIEF DESCRIPTION OF THE DRAWINGS

FIG. 1 is a side perspective view of one embodiment of the present invention.

FIG. 2 is a top perspective view of the embodiment depicted in FIG. 1.

FIG. 3A is a schematic circuit diagram for an embodiment of the invention with a 3V power supply.

FIG. 3B is a schematic circuit diagram for an embodiment of the invention with a 3V power supply, wherein the ambient light detection circuit shares an I/O of the microcontroller with the motion sensor input.

FIG. 4 is a schematic circuit diagram for an embodiment of the invention with a 4.5V power supply.

FIG. 5A is a side perspective view of another embodiment of the present invention.

FIG. 5B is an exploded view of the embodiment depicted in FIG. 5A, emphasizing the optional turret structure.

### DETAILED DESCRIPTION OF THE INVENTION

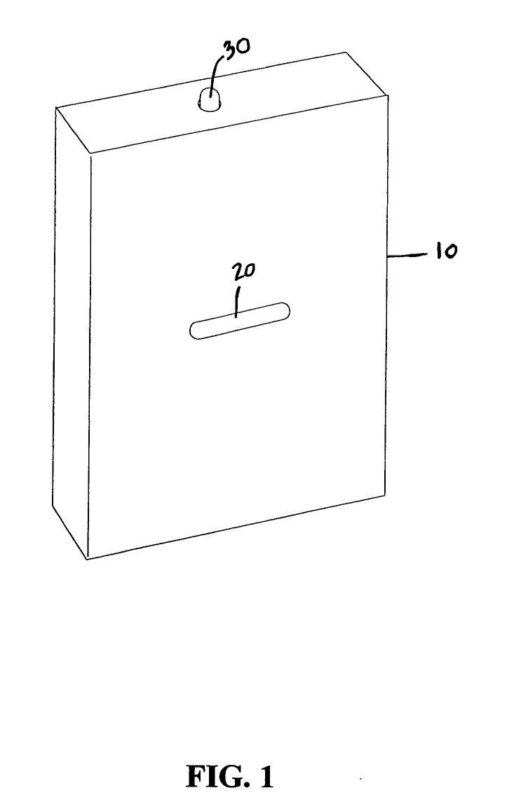

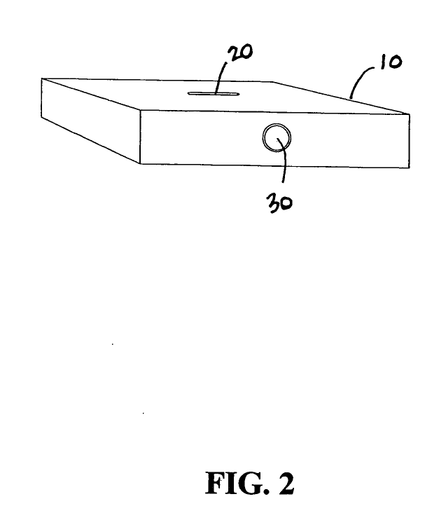

The above described drawing figures illustrate the invention, an economical, motion-actuated night light device. As shown in FIGS. 1 and 2, the device includes a housing (10) formed, for example, from two parts, and made, for example, from injection-molded plastic. The two parts may be snapped together, screwed together, held together with adhesive, or ultrasonically welded together. The preferred embodiment has a snap-in battery compartment cover as part of the rear panel (not shown) to allow the user quick and convenient access for changing the batteries. In the preferred embodiment of the device, the housing (10) is about 2.5″ by 3.5″ by 0.6″ in size. The device may be adapted to rest on the floor, adhere to a wall, or adhere to any other surface with pressure-sensitive adhesive or with a conventional hook-and-loop fastener, and may also have an optional flip-up stand (not shown) for resting in different orientations. Operation of the device preferably depends on two AA alkaline batteries, which are changeable by the user, and which are expected to function for one year at an average of 35 light activations per day. The circuit can be powered by any direct current source from about 2.5 to 5.5 volts. This can include two to four primary cells. With four primary cells, a diode should be included in series with the supply. This will drop the voltage to within 5.5 volts.

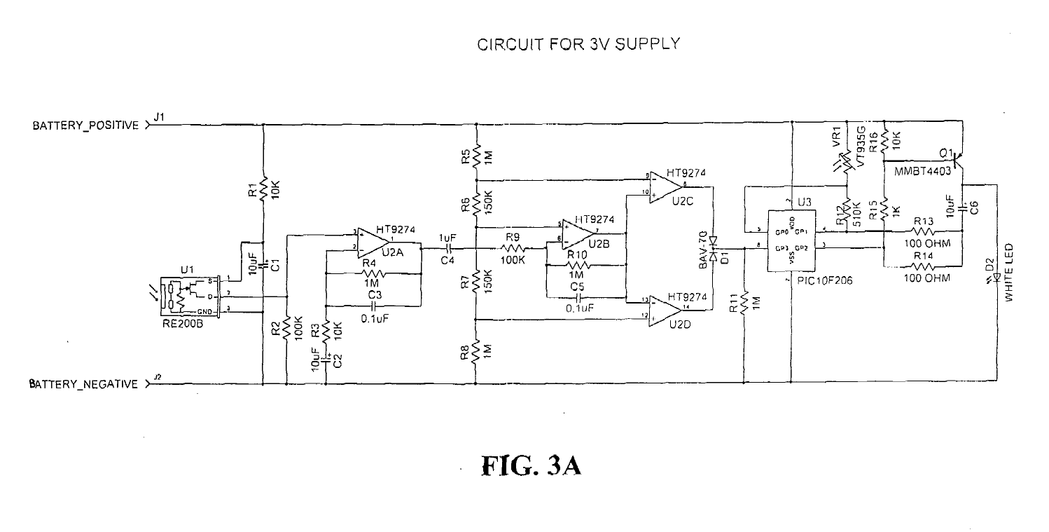

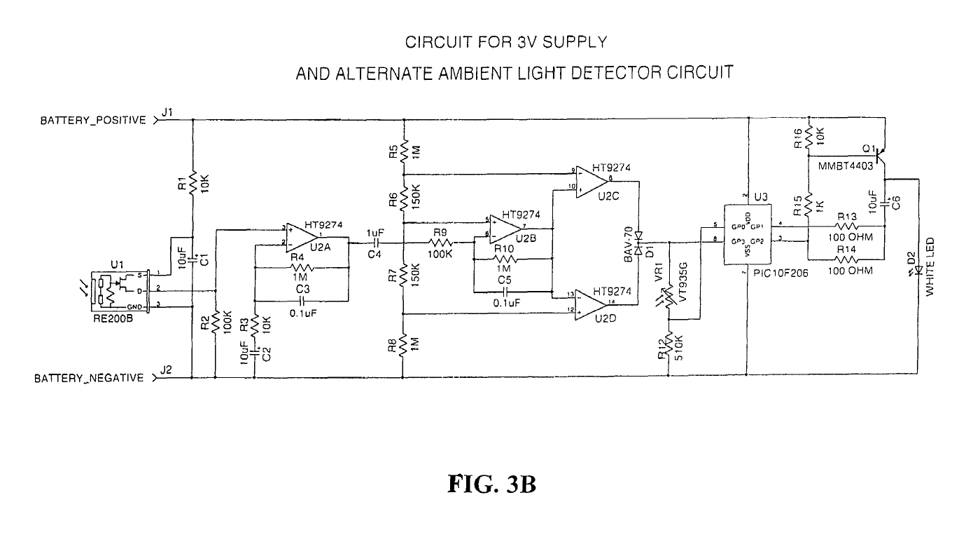

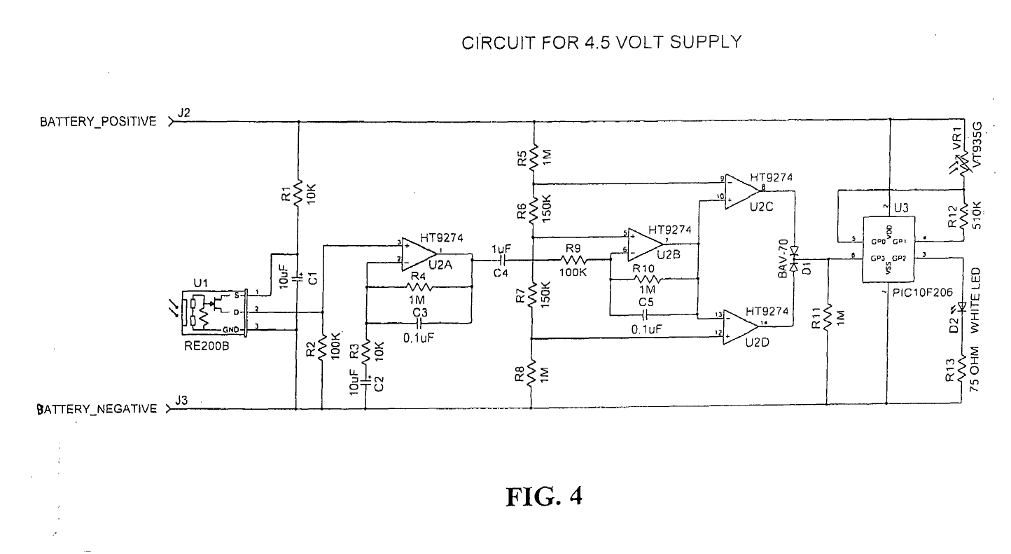

For optimum detection of motion, the ambient temperature surrounding the device must be below 90° F. This is because the device relies on infrared radiation from a moving person against a cooler background, using a pyroelectric infrared (PIR) sensor (U1), shown in FIGS. 3A, 3B, and 4. There are two to four elements in the sensor that collect charge in proportion to the infrared radiation they see. It puts out a small voltage when the amount of charge on the sensing elements is changing. R1 and C1 filter the power supply to the sensor to give very clean power, as any supply noise can cause spurious output. R2 pulls the output toward the low supply voltage. When the sensor is activated, it changes its current output and thereby changes the voltage at the output. When the charge on these elements is unequal, the output level changes, usually by just a few hundred microvolts or a few millivolts.

The sensor signal is AC coupled to a two-stage amplifier (U2A, U2B) to achieve a gain of about 250 times. Capacitors C2 and C3, and resistors R3 and R4 set the amplification and filtering parameters for the first amplification stage. Capacitors C4 and C5, and resistors R9 and R10 set the amplification and filtering parameters for the second amplification stage. This amplifier (U2A, U2B) incorporates high-pass and low-pass filters to achieve a band pass of about 0.5 Hz to 2.0 Hz, which relates to the speed of a relevant moving object, thus filtering out sunlight, moving shadows, and IR interference from remote control devices. This narrow band is the reason the amplification is far below that calculated from the resistor values alone (1010×). The op-amps are chosen to be ultra low power because they are always on. Two op-amps or comparators are used to detect when the amplified signal goes above or below certain thresholds. The thresholds are set at ±200 mV from nominal. When either limit is exceeded, the signal output (D1 anodes) goes positive.

Optical tricks or devices are used to increase the difference between what the two sensors see. A bare sensor can sense to about four feet. A 0.1″ wide slot (20) about 0.4″ long in front of the detector makes a shadow on one element at a time and extends the range to about fifteen feet. Alternatively, a film with shade striping or a lens, such as a Fresnel lens or shadow lens, at the appropriate focal length could also be used with this invention, but the slot (20) is a preferred embodiment for this design because of its low cost. The activation distance is then about 15 feet with a view angle of 20°.

Resistors R5, R6, R7, and R8 center the amplified signal between the high and low power supply and set threshold levels for detection. Comparators U2C and U2D determine when a threshold has been exceeded and then output a digital signal through D1. Resistor R11 keeps the digital signal low when the input signal is between the threshold levels and comparator outputs are low.

A microcontroller U3 or other circuitry can be employed to act upon the motion detection signal. In the preferred embodiment, the microcontroller U3 has a built-in self test so that when the batteries are installed, there should be five short pulses of light one second apart. The microcontroller U3 normally sleeps to conserve power. When the detector signal goes high, the microcontroller U3 wakes up. It first checks ambient light. If the lighting level is above a certain threshold, then it goes back to sleep. If the lighting level is below the threshold, then the LED (30) is turned on for 30 seconds. If there is more motion detected while the LED (30) is on, then the 30 second time period starts over. The microcontroller U3 goes back to sleep when the light period has expired.

To allow for greater light current in the future, two I/Os are used to drive the LED or charge pump for the LED. Therefore, they must always be at the same level. There are only four I/Os on the microcontroller U3. One I/O is used for motion detection, one for ambient light detection, and two are used for the LED. The LED I/Os also provide the function of supplying power to VR1 and R12, where VR1 is a CdS cell which has variable resistance according to incident light. This is why there is a pulse of light every time the microcontroller U3 wakes up due to motion, and tests for ambient light. This is a useful feature to observe triggering, but does use a small amount of power. If the power to the LED (30) does not increase from the current design (12.5 mA) then these functions could be separated by deleting R13. The microcontroller U3 can be programmed on the board. However, because the programming signals share the I/Os used for board functions, if R13 is used, it must be removed during programming, then replaced. Alternatively, the microcontroller U3 can be programmed before insertion into the board.

The microcontroller U3 first pulls two outputs low to apply power to the CdS photosensitive resistor. The level of light is determined by the voltage level between VR1 and R12. The lower the light level, the higher the resistance of VR1. A comparator determines if it is above or below the threshold level. If it is dark, then a low level is detected and the LED (30) will be turned on. If it is too light the microcontroller U3 will go back to sleep. Thus, when the ambient light level is above a specified level so that it is possible to see without artificial light, the device is inactive.

With reference to FIG. 3B, the ambient light detection circuit (VR1 and R12) is moved to share an I/O with the motion sensor input (pin 8 of U3). VR1 and R12 replace R11 for further cost savings. In this embodiment, the I/O is programmed as an input to await a motion sensing signal, which passes through D1. Upon sensing motion, the program changes the I/O at pin 8 to be an output and pulls VR1 high. This allows the voltage between VR1 and R12 to be read by a digital input, comparator input, or A/D input (pin 5 of U3) to determine whether there is little enough light to require turning on the LED (30). While pin 8 is an output, the outputs of U2C and U2D are protected by D1. After the light level is read, the program returns pin 8 to being an input. In the case where two I/Os are needed to drive the LED (30), the circuit of FIG. 3B provides further power savings because checking ambient light will not cause a pulse of light.

If the supply voltage is higher than about four volts, a transistor inside the microcontroller U3, external to it, or in another circuit can connect the LED (30) to a power source to turn it on. Referring to FIG. 4, R13 limits the amount of current through the LED (30) and sets the brightness. Referring to FIGS. 3A and 3B, the charge pump for the preferred, but not the only, embodiment is for use with, for example, a 3V power source when the LED (30) has a forward drop of 3.5V. It may not be possible or practical to directly power the LED (30), however, and the voltage must then be increased with the use of a capacitive charge pump or switching inductor. In the capacitive charge pump shown in FIG. 3A, a capacitor is charged at one voltage, then lifted to another voltage level allowing the charge to dump into the load. R14 is first driven low, and at the same time Q1 is turned on through R15. This charges C6 nearly to the supply voltage. Then R14 is pulled high, which turns off the transistor and lifts the negatively charged pole of the capacitor nearly to the supply voltage. The charge in C6 is thereby poured into the LED (30). Current limiting to, and light intensity from, D2 is accomplished by the value of C6 and the pulsing frequency. At low voltages, the transistor does not allow any charge through itself back to the battery. This small amount of reverse bias does not harm Q1. The pump frequency is 1 kHz.

The device operates using only a single light source, preferably an LED (30), but also an incandescent light source would work, to perform the functions of both night light and flashlight. In this way, the device is energy efficient and cost effective for the user, because battery power is not drained as readily with the operation of a high-intensity beam. One low-intensity beam functions as the night light, and the same low-intensity beam functions as a flashlight when held in the palm of the hand. The single light source focuses its highest intensity lighting in a single direction, and provides the lowest intensity lighting in every other direction, thus minimizing light diffusion in unwanted directions. The advantage of such an arrangement is that a person can use the flashlight to guide them safely to the bathroom or other room in the house during the middle of the night, without viewing a glaring light that is jarring to the eye or potentially waking other people.

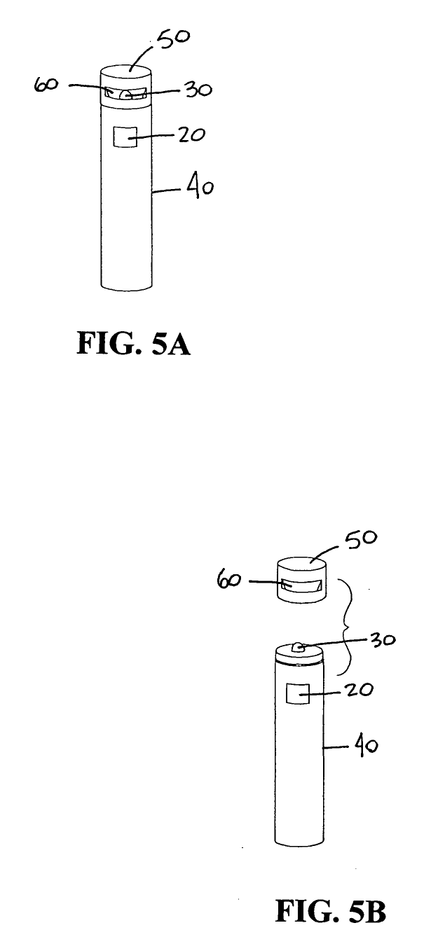

Because different locations may require different sensing and lighting options, an alternate housing embodiment is to place the sensor in the side of a tube (40), as depicted in FIGS. 5A and 5B. A wall-mounted holder could clamp the tube so the sensor faces in any direction. The LED (30) could point axially out the end of the tube and would have an optional turret (50) with a 45° mirror (60) that snaps over the LED (30). Twisting the turret (50) would make the light shine in any radial direction. Also, the sensor could be mounted to receive axially, which would allow a longer focal length for the optics but the tube (40) diameter could be very small. This tube embodiment may be adapted to allow for any combination of sensing direction, illumination direction, and/or location.

Although this invention has been described above with reference to particular means, materials and embodiments, it is to be understood that the invention is not limited to these disclosed particulars, but extends instead to all equivalents within the scope of the following Claims.

What is claimed is:

1. A motion actuated night-light device comprising a single light source only:
wherein the single light source has maximum beam intensity in substantially a single direction, and low beam intensity in substantially all other directions;
wherein the single light source is activated by a motion detector;
wherein the motion detector cooperates with an ambient light sensor, so that the light source is not activated during times of high ambient light;
wherein the night-light device has a housing which has a slot in a side of the housing that is located in front of the detector; and,
wherein the power supply to the device consists of batteries.

2. The device of claim 1 wherein a side of the housing has hook or loop fastener material for bonding to a wall.

3. The device of claim 1 wherein the housing is a tube structure.

4. The device of claim 3 wherein the tube structure includes a turret with a mirror that fits over the light source and/or sensor.

5. The device of claim 1 wherein the light source is a LED.

6. The device of claim 1 wherein the motion detector is a pyroelectric infrared (PIR) sensor.

7. The device of claim 1, which also comprises a microcontroller with a sleep mode, which can be activated upon a motion detection signal.

8. The device of claim 1 which also comprises a charge pump.
